(19) United States
(12) Patent Application Publication
(10) Pub. No.: US 2022/0136480 A1
(43) Pub. Date: May 5, 2022

(54) Modular device for converting wave energy

(71) Applicants: Mykhailo Yuriyovych Lytovchenko, Dnipro (UA); Mykhailo Mykhailovych Lytovchenko, Dnipro (UA)

(72) Inventors: Mykhailo Yuriyovych LYTOVCHENKO, Dnipro (UA); Mykhailo Mykhailovych LYTOVCHENKO, Dnipro (UA)

(21) Appl. No.: 15/767,647

(22) PCT Filed: Sep. 16, 2016
(86) PCT No.: PCT/UA2016/000109

§ 371 Date: Dec. 27, 2021

(30) Foreign Application Priority Data
Oct. 12, 2015 (UA) A 2015 09843

(51) Int. Cl. F03B 13/14; F03B 13/18

(52) U.S. Cl. CPC F03B 13/148; F03B 13/184

(57) ABSTRACT

A modular wave energy converter comprising a rotating wave-receiving chamber made of several working chambers in the form of toroidal segments open on one side and closed on the other side by a valve, wherein the working chambers on one side and/or on the other side are closed by ventilation grilles.

The invention relates to hydropower engineering, namely to devices for converting and using wave energy.

There is a known modular device for using wave energy, comprising a wave-receiving chamber, which is formed by a bottom and guide walls tapering to the impeller location, comprising a central cone-shaped dome and annular-shaped blades that have a section in the form of a symmetrical segment. The wave-receiving chamber is further divided by guide partitions that bend around the impeller and is provided with a hatch and a discharge tray (see Patent of Ukraine No. 36832 AF03B13/12).

The disadvantage of this device is the need to orient the inlet directly against the wave, and this is associated with energy costs comparable or exceeding the expected power of the device. In addition, the vertical location of the impeller rotation axis does not allow the use of gravitational forces that arise during reciprocating motion of water masses in the surface layers of a water body.

There is a known device for converting wave energy on the water surface into mechanical energy that has a horizontal axis of rotation and contains a plurality of containers that are interconnected and uniformly arranged cyclically in series, symmetrically about the axis of rotation and at a certain distance from the axis of rotation and form a solid structure comprising at least one full turn of the containers; wherein each container is limited with a housing that has a front section relative to the direction of device rotation, a rear section relative to the direction of device rotation and the middle section located between the front section and the rear section.

Herewith the rear section of each housing has an inlet opening through which the internal cavity of the container communicates with the environment, and the front section of the container housing is provided with a valve, which enables passage of fluid only in the inward direction to the container and prevents flow of the fluid in the outward direction from the container (see Patent of Ukraine UA No. 62659, FO3B13/12).

The disadvantages of the device include the use of valves and their bad location. The authors suggest that a certain part of the useful work will be carried out at the expense of the weight of the water held in the container behind the closed valve located in the front section of the container. In static, this will certainly give a torque to the entire device. But, in dynamics, this leads to the fact that when the whole structure rotates, there is a counter-impact or “slap” of the rising wave upon the container front sections closed with the valves, which must be lowered. And, since the valves have a significant hydraulic resistance, then there are significant reversible loads that counteract the force of gravity to these containers and Archimedes' force to opposite containers and stop the rotation of the entire device. And this in turn leads to the fact that the device does not have time to work efficiently with further lowering of the wave due to the need to overcome the inertia force in order to perform the desired rotational motion.

The closest by the technical essence and reachable effect to the claimed converter is a modular device for converting wave energy [utility model patent UA No. 75844, FO3B13/12. Modular device for converting wave energy/Litovchenko Mikhail Yuryevich, Litovchenko Mikhail Mikhailovich applied on Jul. 2, 2012, published on Dec. 10, 2012] (prototype), which includes a rotatable wave-receiving chamber made of several working chambers in the form of toroidal segments, open on one side and closed on the other side with the valve.

The disadvantages of the prototype include the use of valves to regulate the liquid flow, which are depicted in the corresponding drawing in the form of a plate or a thick plate. While testing the model of a small size, the valve performed its functions confidently enough and at the right time. But, when trying to increase the power of the device by increasing its geometric dimensions and the cross-section of the working chambers, certain problems arose during the subsequent field experiments. The valve constantly “delayed” and the water did not have time to empty duly the corresponding working chamber. Various elastic materials for the valve have been tested, but all in vain. The reason was that behind the valve the water remained stationary relative to the chambers and the valve with the whole plane “leaned” against it. And this prevented it from opening fully in time. And in the semi-open position, it overlapped most of the open flow area, thereby creating additional hydraulic resistance. As a result, the process of filling and emptying the working chambers with water was prolonged when the wave was raised or lowered, which led to extremely undesirable reverse loads. And since the valve was in this position for sufficiently long time, it constantly slowed down and sometimes even stopped the rotation of the device, which greatly reduced its real efficiency.

The invention is based on the task of improving the device for converting wave energy, in particular, the design of working chambers, which will allow using kinetic energy of the reciprocal motion of surface waves without losses, regardless of their size, direction and configuration.

The problem is solved by the fact that in the known modular wave energy converter, comprising a rotating wave-receiving chamber made of several working chambers in the form of toroidal segments open on one side and closed on the other side with the valve, according to the invention, the working chambers on one and/or on the other side are covered with ventilation grilles.

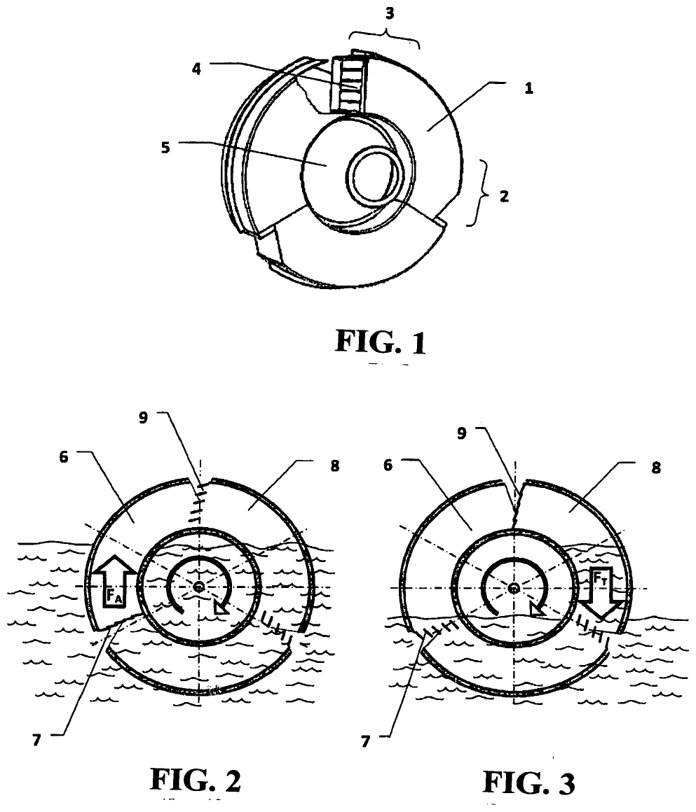

The claimed invention is represented in FIG. 1 by a general view of the module comprising one rotating wave-receiving chamber, which consists of three working chambers, and a fragment of the central body (hereinafter referred to as the module) in configuration with closed ventilation grilles on the rear sides of the working chambers. Ventilation grilles in the drawing version are depicted with rigid, flat moving shutters. To explain the operating principle, FIG. 2 and FIG. 3 show the dynamic schemes. The working chamber 1 depicted in FIG. 1 is fixed to the fragment of the central body 5 and has a front side 2 and a rear side 3 20 relative to the direction of rotation. In the drawing, the rear side 3 of the working chamber 1 is closed by a ventilation grill 4. But in some cases, depending on the conditions of use, the working chamber is closed by ventilation grilles on the front side or on both sides simultaneously. The choice is made individually in each case and is affected primarily by the capacity to prevent clogging and fouling of surfaces by floating algae or molluscs, as well as by the geometric dimensions of the device that depend on the average wave height in the water area of operation. For the convenience of service and transportation in disassembled form, each working chamber can be independently made of two or more parts folding compactly into each other. The modules assembled at the site of operation are attached coaxially to each other or to a shaft, an axle or any supporting structure. To transfer the resulting rotary motion 30 to a generator, pump or other device for performing useful work, a drive shaft of arbitrary design is used, which is not shown in the figures.

The claimed device operates as follows. The modular wave energy converter is fixed by any known method at the installation site so as to be on the surface of the water in semi-submerged state. If necessary, the use of hollow floats is possible to ensure buoyancy. The incoming waves will arbitrarily temporarily flood and drain individual working chambers, creating at the same time an imbalance of forces that ensures the rotation of the entire device and the transfer of torque to the device to perform useful work, which is not shown in the figure. The circular movement of the working chambers can be conditionally divided into the areas of descent (immersion) and ascent (emersion). The device operation principle is shown in FIG. 2 and FIG. 3 on the example of the cross section of one module of three working chambers:

Phase 1, depicted in FIG. 2: Wave elevation and the relative “immersion” of the module.

On the working chamber 6, which conditionally “ascents” on the ventilation grille 7, the shutters are closed under the effect of excessive pressure, which prevents the flow of water from outside into the chamber, and the Archimedes' buoyant force FA acts on it, creating a torque. In the working chamber 8, which “descends”, the shutters on the ventilation grille 9 can be freely opened and it is easily filled with water according to the principle of communicating vessels.

Phase 2, depicted in FIG. 3: Wave lowering and the relative “emersion” of the module. The water that filled the working chamber 8 during the “immersion” of the module tries to leave the chamber and this creates a certain vacuum in it, leading to the closing of the shutters on the ventilation grille 9. As a result, water can no longer leave the chamber and its weight FT creates a torque in the same direction as the Archimedes' buoyant force FA during the “immersion” in the first phase. In the working chamber 6, which “ascents”, if necessary, the shutters are opened on the ventilation grille 7 and it is freely released from the water, not opposing the rotation of the module.

To confirm the correctness of the assumptions, we built a prototype of one wave energy converter module and conducted the tests first in the laboratory and then in real conditions on the Sea of Azov. The overall diameter of the module was 1200 mm, the cross-section of the working chambers was 300×300 mm. The module consisted of three working chambers, closed from the rear side with respect to the direction of rotation by ventilation grilles with movable shutters. Of course, the shutters did not provide such tightness, as the valves. However, as a result, they had much less hydraulic resistance, while insignificant losses from fluid leakage were more than offset by the positive torque created by the other working chambers.

In the laboratory, one separate working chamber was gradually lowered and raised in a rectangular container with water with amplitude of 250 mm and a period of 4 seconds. In full-scale tests, the height of a real wave ranged within 300 mm with a period of about 3-4 seconds. The tests were successful and fully confirmed the possibility of stable operation of the device. Both during the ascent and descent of the wave, the prototype of the device received the desired impulse from the action of Archimedes' force or gravity, and it was continuously turned. The main thing is that in the dynamic scheme there were no reversible loads, which, in turn, led to the stable operation of the entire device and a significant increase in its efficiency.

The carried out tests and preliminary calculations show that the proposed modular wave energy converter can be effectively used as an energy source in coastal and island areas.

1. A modular wave energy converter fixed in an arbitrary manner, rotatable in a semi-submerged position on the water surface, the modular wave energy converter comprising:
at least one wave-receiving chambers coaxially fixed on a common shaft or hollow body, each of which is made of several working chambers in the form of toroidal segments, closed on the first sides by the first valves, wherein the first ventilation grilles with moving shutters are used as the first valves, while the working chambers on the second sides are open or closed by the second ventilation grilles.

2. The modular device as set forth in claim 1, wherein the first sides of the working chambers are the rear sides in the direction of rotation of the device.

3. The modular device as set forth in claim 2, wherein the first valves in the form of the first ventilation grilles are adapted to close their shutters when the pressure inside the working chambers is lower than the external pressure.

4. The modular device as set forth in claim 3, wherein the second ventilation grilles are made similar to the first ventilation grilles in the form of ventilation grilles with movable shutters that are used as the second valves.

5. The modular device as set forth in claim 4, wherein the second sides of the working chambers are the front sides in the direction of rotation of the device.

6. The modular device as set forth in claim 5, wherein the second ventilation grilles are adapted to close their shutters when the pressure inside the working chambers exceeds the external pressure.

7. The modular device as set forth in claim 6, wherein the shutters of the first and/or second ventilation grilles are made of a plurality of rigid, flat, narrow, movable (rotary) plates.
